(19) United States
(12) Patent Application Publication
(10) Pub. No.: US 2022/0111284 A1
(43) Pub. Date: Apr. 14, 2022

(54) METHOD AND SYSTEM FOR GOLF TRAINING

(71) Applicant: AI GOLF UG (HAFTUNGSBESCHRÄNKT), Berlin (DE)

(72) Inventors: Michael WASAG, Potsdam (DE); Stefan FLEMMING, Berlin (DE)

(21) Appl. No.: 17/421,080

(22) PCT Filed: Jan. 8, 2020
(86) PCT No.: PCT/EP2020/050273

§ 371 Date: Dec. 13, 2021

(30) Foreign Application Priority Data
Jan. 8, 2019 (DE) 10 2019 100 314.8

(51) Int. Cl. A63B 71/06; A63B 57/30; A63B 24/00

(52) U.S. Cl. CPC A63B 71/0622; A63B 57/357; A63B 71/0616; A63B 24/0021; A63B 2220/40; G01S 19/19; A63B 2220/833; A63B 2220/805; A63B 2220/70; A63B 2220/18; A63B 2220/12; A63B 2220/801

(57) ABSTRACT

Method for playing golf comprising acquiring a striking position of a golfer; acquiring flag information of a golf flag, which flag information comprises a flag position of the golf flag and information relating to a hole belonging to the golf flag; acquiring an acceleration of the golfer or of a golf club; outputting an associated striking time when a magnitude of the acquired acceleration lies above a predetermined threshold value; acquiring the surroundings of the golf flag upon receiving the striking time; checking the arrival of a golf ball in the surroundings and determining and outputting an assessment, in particular a point value, on the basis of the flag information, the striking position and the determined location using a to stored assessment system.

Golfers need training to develop their skills; this includes both playing rounds on golf courses and explicit training sessions in a training facility. To support the motivation of the player, systems are already known that golfers can use to record and compare their strokes electronically in order to be more motivated by the idea of competition, as described in WO 97/01376. For this purpose, in WO 97/01376, the green or a target area is permanently monitored by a camera and a point value is determined solely on the basis of the position of a golf ball in the target area.

In the state of the art, it is not possible to consider further influencing factors and conclusions drawn from them to support the training effect.

This is where the invention begins, the object of which is to provide a method and a system for golf training that can be used to improve the experience and effectiveness of golf training and the game of golf.

According to a first aspect of the invention, this is achieved by a method for golf training comprising the following steps:

Acquiring a striking position of a golfer;

Acquiring flag information of a golf flag, comprising a flag position of the golf flag and information relating to a hole belonging to the golf flag;

Acquiring an acceleration of the golfer or a golf club;

Outputting an associated striking time when a magnitude of the detected acceleration is above a predetermined threshold value;

Acquiring the surroundings of the golf flag upon receiving the striking time;

Checking for the arrival of a golf ball in the surrounding area;
If a golf ball is detected in the area surrounding the golf flag:
   Locating the golf ball;
   Determining and outputting a position of the golf ball relative to the golf flag after it reaches a rest position;

Determining and outputting an assessment, in particular a point value, based on the flag information, the striking position, and the determined location using a stored assessment system.

The invention is based on the knowledge that, in addition to a position of the golf ball at the end of a stroke, other aspects such as the position of the player during the stroke, but also specific information about the hole or the training unit to which the golf flag belongs must be considered to create a comparability of assessments, on the one hand, and to be able to draw conclusions for further targeted training needs on the other hand. Only if these further parameters are taken into consideration is it possible to use the information to establish an adequate evaluation and assessment of the skills of a golfer, which are used as a basis for further playing and training. In addition, by combining the striking time and the detection of the area around the golf flag, it is possible to acquire an area around the flag in an energy-efficient manner only when a player is actually playing at the respective hole or the respective training unit and wishes to monitor his/her game in this way. For example, if players playing at the hole do not have any sensors to record the striking position and striking time, it is not necessary to acquire the area around the golf flag.

In the context of the invention, an assessment is understood to mean both classifications based on a single scale, such as point values, and more detailed evaluations in which, for example, different classifications are made regarding different aspects of golf training, i.e. different scales are used for different aspects, for example. In addition to point values, the classifications can also include comments such as good, in need of improvement, or the like, for example.

Advantageous embodiments of the method according to the invention will be described below. The additional features of the exemplary embodiments can be combined to form further embodiments, unless the description expressly characterizes them as alternatives to each other.

In a preferred embodiment, the method further comprises, each time a further acceleration of a magnitude that is above the predetermined threshold value is detected, determining and outputting a current striking position and a further striking time, wherein the number of further striking times and/or the current striking positions are also taken into consideration when making the assessment. In this embodiment, it can thus also be taken into consideration how many strokes the golfer needed to reach the area around the golf flag, as well as what his/her steps were to approach the golf flag.

In a further embodiment, the method comprises the following steps:

Detecting a vibration of a container attached to the flag position for receiving golf balls

Outputting a hole-out signal, which indicates the hole-out of a golf ball, when a vibration is detected, the magnitude of which exceeds a predetermined vibration threshold value.

This makes it possible to automatically record a hole-out. The vibration is preferably detected by an acceleration sensor. In a further development of this embodiment, the number of further striking times until the hole-out is achieved can then be taken into account when making the assessment.

The striking position and/or the current striking position preferably comprises location information and orientation information, wherein the location information is preferably GPS information. Location information and orientation information can be used to draw further conclusions for the evaluation of the golf game in order to optimize the training, or the orientation information can be used to specifically activate a flag sensor that is arranged in a direction corresponding to the orientation.

In a further embodiment, the method comprises the steps of determining and outputting an anticipated corridor for a movement of the golf ball and a time window for the arrival of the golf ball in the vicinity of the golf flag based on the striking position together with the striking time, with a speed of the golf ball determined based on the acceleration of the golfer or golf club, and/or with the flag position of the golf flag, or based on the current striking position together with the further striking time, with the speed of the golf ball and/or with the known flag position. In a further development of this embodiment, the information about the anticipated corridor makes it possible for an optical sensor arranged at the golf flag to be aligned in order to acquire the surroundings in accordance with the anticipated corridor and the time window. The optical sensor preferably includes a camera.

The flag information of the golf flag preferably includes at least one of the following information: information on the soil condition in the vicinity of the flag, elevation information, degree of difficulty of an associated hole, weather parameters, gradient information. This information enables a more differentiated assessment of the golf training.

The method preferably further comprises the following steps:

Detecting a type of club used in each case;

Including the respective type of club used when making the assessment, which also makes it possible to consider the selection of the club in the assessment or in a subsequent evaluation of the golf training.

In a further embodiment, the method also comprises establishing and outputting a player ranking based on obtained assessments.

The assessment is preferably output to a mobile device of the golfer so he/she can be informed continually about the assessment during the training.

In one embodiment, the method further comprises the following steps:

Taking a picture of the surroundings of the golf flag

Displaying the image of the surroundings, in particular after a golf ball has been located in the surroundings, on a mobile device of the golfer, thereby enabling the golfer to visualize the situation.

In addition, the flag information, the striking position, the striking time, the current striking positions, the further striking times and/or the detected position are preferably output to the mobile device.

In a multi-player mode, the method preferably further comprises outputting the flag information, the striking position, the detected position, the current striking positions and the number of striking times, as well as the assessment of each golfer to the devices of additional golfers.

In a further embodiment, the method comprises the following steps:

Establishing a golf task based on the acquired flag information as well as stored already obtained assessments of the golfer, and outputting the golf task to a mobile device; and/or

Establishing at least one game improvement suggestion based on the flag information, the striking position, the striking time, the current striking positions, the further striking times of the detected location, the assessment and/or stored assessments already obtained, and outputting the game improvement suggestion to a mobile device.

Targeted improvements of the training or playing skills are possible based on the information gained from the individual strokes. A golf task means, for example, a task for the player to execute strokes with a specific club or at a defined distance or to specific targets. Game improvement suggestions are instructions on how the game of golf can be improved, for example by changing the body posture or club position, changing the application of force, changing the swing behavior, or choosing a different club.

It is preferred that, in a multi-player mode, the further steps of determining at least one fellow player based on stored obtained assessments of golfers and outputting the golf task to devices of the golfer and the at least one fellow player are also carried out. Golfers can use this information to compete in direct comparison.

In a further embodiment, the method comprises projecting at least one object or a shape, such as target circles, landing points, markers, gradients of the green or the like, onto the green. Corresponding objects or shapes are preferably selected in advance based on user inputs and/or using obtained assessments and/or based on the flag information. Alternatively, or additionally, an image of the green with the respective object and/or shape is output to a mobile device. This can also be part of a golf task or a game improvement suggestion, for example.

In a further embodiment, at least one putt line is projected onto the green, preferably an optimal putt line that is determined in advance based on the flag position and a location of the golf ball. Alternatively, or additionally, the at least one putt line is output to a mobile device together with an image of the green.

This information can be used to further train and optimize the game of golf. According to a second aspect, the invention relates to a system for golf training comprising

A position sensor which is designed to acquire and output a striking position of a golfer;

An acceleration sensor which is designed to acquire and output an acceleration of the golfer or a golf club;

A first evaluation unit which is designed to determine a magnitude of acceleration based on the acquired acceleration and to compare it with a predetermined threshold value and, if the magnitude of the acquired acceleration is above the predetermined threshold value in terms of its amount, to output the striking position of the golfer and an associated striking time;

A flag sensor which is arranged on or in the immediate vicinity of a golf flag and designed, in response to receiving a striking time,
to acquire the surroundings of the golf flag;
to check the surroundings for the arrival of a golf ball and, when a golf ball is detected, to locate it in the surroundings of the golf flag;
to determine whether the golf ball has reached a rest position and, after the rest position has been detected, to determine and output a position of the golf ball relative to the golf flag;

A second evaluation unit, which is designed
to receive the striking position and the detected location, and
to make and output an assessment based on a flag information of the golf flag, comprising a flag position of the golf flag and information about a hole belonging to the golf flag, the striking position and the determined location using a stored assessment system.

The first position sensor and the acceleration sensor can be installed in a common housing, which is preferably designed to be worn on the golfer's body or on the club.

The flag sensor preferably comprises a flag sensor control unit which is designed to activate the flag sensor upon receipt of a striking time. In this embodiment, the flag sensor can remain in idle mode as long as no striking time has been received and can thus be used in an energy-efficient manner.

In one embodiment, the second evaluation unit is additionally designed to consider the number of striking times, current striking positions and/or types of clubs used when making the assessment.

The first position sensor preferably includes a GPS sensor, a gyroscope and/or a magnetoscope. In addition, the flag sensor can comprise a camera or a radar device.

In a further embodiment, the system for golf training additionally comprises a vibration sensor which is attached to a container for receiving golf balls that is attached to the flag position and designed to detect a vibration of the container. A hole-out of the golf ball can be reliably detected with this vibration sensor.

Furthermore, it is advantageous if the system additionally comprises a sensor for identifying golf clubs, in particular an RFID sensor, more particularly an NFC sensor. Information about the club can be made available via this sensor and incorporated into the assessment and evaluation of the golfer.

It is advantageous if the second evaluation unit is further designed

to establish a golf task based on the acquired flag information as well as stored assessments of the golfer already obtained, and to output the golf task to a mobile device; and/or

to establish at least one game improvement suggestion based on the flag information, the striking position, the striking time, the current striking positions, the further striking times of the determined location, the assessment and/or stored assessments already obtained, and to output it to a mobile device.

This way the golfer's training can be optimized in a targeted manner through the selection of tasks or the game improvement suggestions.

The second evaluation unit is preferably designed in the form of a computer program product. In one embodiment, the first evaluation unit is also designed as a computer program product. The computer program products can be stored both on servers and directly on the golfer's mobile devices. In one embodiment, the first and second evaluation units are designed as a common evaluation unit that assumes the functions of the first and second evaluation units.

In a further embodiment, the system comprises a laser or a projector which is designed to project at least an object or a shape, such as target circles, landing points, markers, gradients of the green or the like, onto the green. The laser or projector is connected to the second evaluation unit which, in this embodiment, is designed to select corresponding objects or shapes based on user inputs and/or based on obtained assessments and/or based on the flag information, and to send a signal to the laser or projector to output the corresponding object. Alternatively, or additionally, the evaluation unit can be designed to output an image of the green with the corresponding object and/or shape to a mobile device. This can, for example, also be part of a golf task or a game improvement suggestion. In a further embodiment, the laser or projector is alternatively, or additionally, designed to display at least one putt line on the green, preferably an optimal putt line, and the second evaluation unit is accordingly designed to determine at least one putt line, preferably an optimal putt line, based on the flag position and a location of the golf ball, and to output it to the laser or projector. Alternatively, or additionally, the evaluation unit is designed to output the at least one putt line to a mobile device together with an image of the green.

This information can be used to further train and optimize the game of golf.

Apart from that, the system shares the advantages and embodiments of the method according to the first aspect of the invention.

Examples of embodiments are also indicated in the claims.

In the following, further exemplary embodiments will be described based on the drawing. It shows the following:

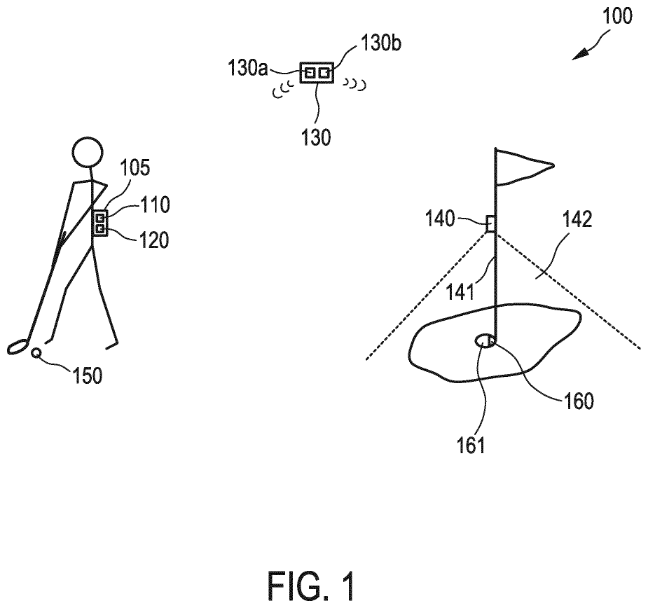

FIG. 1 A schematic representation of an exemplary embodiment of a system for golf training.

In the embodiment shown in FIG. 1, the system 100 for golf training comprises a position sensor 110. The position sensor 110 is designed to detect and output a striking position of a golfer. In the embodiment shown, the position sensor comprises both a GPS sensor and a gyroscope so that the position sensor can output a striking position and/or the current striking position, which includes location information and orientation information. In addition, the system 100 comprises an acceleration sensor 120, which is designed to acquire and output an acceleration of the golfer. The position sensor 110 and the acceleration sensor 120 are arranged in a common housing 105 here, which is worn on the body of the golfer. The housing can be attached to a golfer's belt, for example by means of a clip.

In the embodiment shown, a first evaluation unit 130a and a second evaluation unit 130b are implemented as a common evaluation unit 130, which is stored on a server as a computer program product. In alternative embodiments, one of the evaluation units is stored on a mobile device and the other is stored on a server, or both on the mobile device. The first evaluation unit 130a is designed to determine a magnitude of acceleration based on the acquired acceleration and to compare it with a predetermined threshold value and, if the magnitude of the acquired acceleration is above the predetermined threshold value in terms of its amount, to output the striking position of the golfer and an associated striking time. The information is output to a flag sensor 140 that is arranged on a golf flag 141 in this case. Upon receipt of the striking time, the flag sensor 140, which can be designed as a camera, for example, acquires a surrounding area 142 of the golf flag 141 and checks it for the arrival of a golf ball 150; if it detects a golf ball 150, it locates it in the area surrounding the golf flag. Furthermore, the flag sensor 140 is designed to determine whether the golf ball 150 has reached a rest position and, after the rest position has been determined, to identify and output a location of the golf ball relative to the golf flag; The second evaluation unit 130b is designed to receive the striking position and the identified location, and to make and output an assessment based on a flag information of the golf flag 141, comprising a flag position of the golf flag and information about a hole belonging to the golf flag, the striking position, and the identified location using a stored assessment system. Whenever the acceleration sensor 120 detects a further acceleration, the magnitude of which is above the predetermined threshold value, a current striking position and a further striking time are output. This information is also incorporated into the assessment so that a number of strokes up to the hole-out can be considered. In the embodiment shown, the hole-out itself is detected by a vibration sensor 160, which is attached to a container for receiving golf balls that is attached to the flag position, here at hole 161, and that is designed to detect a vibration of the container. The assessment is preferably output to a mobile device of the golfer, to which mobile device images of the surroundings, the flag information, the striking position, the striking time, the current striking positions, the further striking times and/or the identified location are preferably also output in addition to the assessment. In the embodiment shown, the second evaluation unit 130b is further designed to establish a golf task based on the acquired flag information as well as stored assessments of the golfer already obtained, and to output this golf task to a mobile device. Alternatively, or additionally, it can determine at least one game improvement suggestion based on the flag information, the striking position, the striking time, the current striking positions, the further striking times of the identified location, the assessment and/or stored assessments already obtained, and to output it to the mobile device of the golfer. This way the golfer is given specific exercises or suggestions for improvement based on his/her previous strokes or game results in order to optimize his/her training.

In addition, the system can also be equipped for a multi-player mode. In this mode, the second evaluation unit 130b also outputs flag information, striking position, identified location, current striking positions and the number of striking times as well as the assessment of each golfer to devices of additional golfers, who can then use this information to compare themselves with one another. In addition, in the multi-player mode, the second evaluation unit can be designed to determine at least one fellow player for the golfer based on the stored assessments of golfers obtained, and to output a golf task to the devices of the golfer and the at least one fellow player. Golfers can use this information to compete in direct comparison.

1. A method for playing golf comprising the following steps:
acquiring a striking position of a golfer
acquiring flag information of a golf flag, comprising a flag position of the golf flag and information relating to a hole belonging to the golf flag;
acquiring an acceleration of the golfer or a golf club;
outputting an associated striking time when a magnitude of the detected acceleration is above a predetermined threshold value;
acquiring the surroundings of the golf flag upon receiving the striking time;
checking for the arrival of a golf ball in the surrounding area;
if a golf ball is detected in the area surrounding the golf flag:
locating the golf ball;
determining and outputting a position of the golf ball relative to the golf flag after it reaches a rest position;
making and outputting an assessment, in particular a point value, based on the flag information, the striking position, and the determined location using a stored assessment system.

2. The method according to claim 1, further comprising the following steps:
whenever a further acceleration is detected, the magnitude of which is above the predetermined threshold value, determining and outputting a current striking position and a further striking time;
wherein the number of further striking times and/or the current striking positions are considered when making the assessment.

2. The method according to claim 1, further comprising the following steps:
detecting a vibration of a container attached to the flag position for receiving golf balls
outputting a hole-out signal which indicates the hole-out of a golf ball when a vibration is detected, the magnitude of which exceeds a predetermined vibration threshold value in terms of its amount.

4. The method according to claim 3, wherein the number of further striking times up to the hole-out are considered when making the assessment.

5. The method according to claim 1, wherein the striking position and/or the current striking position comprises a location information and an orientation information.

6. The method according to claim 1, further comprising the following steps:
determining and outputting a probable corridor for a movement of the golf ball and a time window for the arrival of the golf ball in the vicinity of the golf flag based on the striking position together with the striking time, with a speed of the golf ball determined based on the acceleration of the golfer or golf club and/or with the flag position of the golf flag, or based on the current striking position together with the further striking time, with the speed of the golf ball and/or with the known flag position.

7. The method according to claim 6, further comprising the following step:
aligning an optical sensor arranged at the golf flag for acquiring the surroundings in accordance with the probable corridor and the time window.

8. The method according to claim 1, wherein the flag information of the golf flag includes at least one of the following information: information about the soil condition in the vicinity of the flag, elevation information, degree of difficulty of an associated hole, weather parameters, gradient information.

9. The method according to claim 1, further comprising the following steps:
acquiring a type of club used in each case;
incorporating the type of club used when making the assessment.

10. The method according to claim 1, further comprising the following step:
establishing and outputting a player ranking based on assessments obtained.

11. The method according to claim 1, wherein the assessment is output to the golfer's mobile device.

12. The method according to claim 1, further comprising the following steps:
taking a picture of the surroundings of the golf flag
displaying the image of the surroundings, in particular after a golf ball has been located in the surroundings, on a mobile device of the golfer.

13. The method according to claim 1, further comprising the following step:
in a multi-player mode, outputting the flag information, the striking position, the detected location, the current striking positions, and the number of striking times as well as the assessment of each golfer to the devices of additional golfers.

14. The method according to claim 1, further comprising the following steps:
establishing a golf task based on the acquired flag information as well as stored assessments of the golfer already obtained, and outputting the golf task to a mobile device; and/or
establishing at least one game improvement suggestion based on the flag information, the striking position, the striking time, the current striking positions, the further striking times of the detected location, the assessment and/or stored assessments already obtained, and outputting the game improvement suggestion to a mobile device.

15. The method according to claim 14, further comprising the following steps:
in a multi-player mode, determining a fellow player based on stored assessments of golfers obtained;
outputting the golf task to the devices of at least two golfers.

16. A system for golf training, comprising:
a position sensor which is designed to acquire and output a striking position of a golfer;
an acceleration sensor which is designed to acquire and output an acceleration of the golfer or a golf club;
a first evaluation unit which is designed to determine a magnitude of acceleration based on the acquired acceleration and to compare it with a predetermined threshold value and, if the magnitude of the acquired acceleration is above the predetermined threshold value in terms of its amount, to output the striking position of the golfer and an associated striking time;
a flag sensor which is arranged on or in the immediate vicinity of a golf flag and designed, in response to receiving a striking time,
to acquire the surroundings of the golf flag;
to check the surroundings for the arrival of a golf ball and, when a golf ball is detected, to locate it in the surroundings of the golf flag;
to determine whether the golf ball has reached a rest position and, after the rest position has been detected, to determine and output a position of the golf ball relative to the golf flag;
a second evaluation unit, which is designed
to receive the striking position and the detected location, and
to make and output an assessment based on a flag information of the golf flag, comprising a flag position of the golf flag and information about a hole belonging to the golf flag, the striking position and the determined location using a stored assessment system.

17. A system for golf training according to claim 16, further comprising a vibration sensor which is attached to a container for receiving golf balls that is attached to the flag position and designed to detect a vibration of the container.

18. A system for golf training according to claim 16, further comprising a sensor for identifying golf clubs, in particular an RFID sensor, more particularly an NFC sensor.

19. A system for golf training according to claim 16, in which the second evaluation unit is further designed
to establish a golf task based on the acquired flag information as well as stored assessments of the golfer already obtained, and to output the golf task to a mobile device; and/or
to establish at least one game improvement suggestion based on the flag information, the striking position, the striking time, the current striking positions, the further striking times of the determined location, the assessment and/or stored assessments already obtained, and to output it to a mobile device.

20. A system for golf training according to claim 16, in which the second evaluation unit is designed in the form of a computer program product.
